(19) United States
(12) Patent Application Publication
(10) Pub. No.: US 2018/0012684 A1
(43) Pub. Date: Jan. 11, 2018

(54) METHOD FOR PRODUCING INSULATED ELECTRIC WIRE

(71) Applicant: MITSUBISHI MATERIALS CORPORATION, Tokyo (JP)

(72) Inventors: Shintaro IIDA, Naka-shi (JP); Hideaki SAKURAI, Naka-shi (JP)

(73) Assignee: MITSUBISHI MATERIALS CORPORATION, Tokyo (JP)

(21) Appl. No.: 15/544,159

(22) PCT Filed: Feb. 5, 2016
(86) PCT No.: PCT/JP2016/053489

§ 371 Date: Jul. 17, 2017

(30) Foreign Application Priority Data
Feb. 13, 2015 (JP) 2015-026041

(51) Int. Cl. H01B 13/16; C25D 13/16; C09D 5/44; C25D 13/00; H01B 13/00; C25D 13/20

(52) U.S. Cl. CPC H01B 13/16; H01B 13/0016; C25D 13/20; C09D 5/4461; C25D 13/00; C25D 13/16

(57) ABSTRACT

A method for producing an insulated electric wire of the present invention is a method for forming an insulating coating film on a surface of an electric wire by performing baking treatment after forming an insulating layer on the surface of the electric wire by an electrodeposition method using an insulating electrodeposition coating material containing a polymer. Pretreatment of evaporating a solvent in the insulating layer is performed before the baking treatment, and the pretreatment is performed by a near infrared ray heating furnace. In addition, a temperature of the pretreatment is lower than a temperature of the baking treatment.

### CROSS-REFERENCE TO RELATED PATENT APPLICATIONS

This application is a U.S. National Phase Application under 35 U.S.C. §371 of International Patent Application No. PCT/JP2016/053489 filed on Feb. 5, 2016 and claims the benefit of Japanese Patent Application No. 2015-026041 filed on Feb. 13, 2015, all of which are incorporated herein by reference in their entirety. The International Application was published in Japanese on Aug. 18, 2016 as International Publication No. WO/2016/129518 under PCT Article 21(2).

### FIELD OF THE INVENTION

The present invention relates to a method for producing an electric wire coated with an insulating layer by electrodeposition coating.

### BACKGROUND OF THE INVENTION

From the related art, an insulated electric wire in which a surface of an electric wire is coated with an insulating coating film is used in a motor, a reactor, a transformer or the like. As a method for forming the insulating coating film on the surface of the electric wire, a dipping method or an electrodeposition method is known.

Here, the electrodeposition method is a method for forming the insulating coating film by allowing the electric wire that becomes a core of the insulated electric wire to pass through an insulating electrodeposition coating material containing a polymer, by electrodepositing the polymer on the surface of the electric wire while the electric wire is energized, and further, by baking the electrodeposited polymer (for example, refer to Japanese Unexamined Patent Application, First Publication No. 2004-342330 (Claim 1, Paragraphs [0066] to [0070] and [0080])). In forming the insulating coating film on the surface of the electric wire by the electrodeposition method, it is possible to perform the forming by using an electric wire electrodeposition coating apparatus in which electrodeposition means and heating means are combined in this order. The electrodeposition means is for forming the insulating layer on the surface of the electric wire by allowing the electric wire that becomes the core of the insulated electric wire to pass through the insulating electrodeposition coating material containing a polymer, and by allowing the electric wire to be energized. In addition, the heating means is for baking the polymer electrodeposited on the surface of the electric wire. Examples of the heating means can include a hot air drying oven, a near infrared ray heating furnace, a far infrared ray heating furnace, an induction heating furnace or the like.

In the coating method of the electric wire configured in this manner, it is possible to obtain the insulated electric wire in which the insulating coating film is formed on the electric wire.

### Technical Problem

However, in the coating method of the electric wire illustrated in Japanese Unexamined Patent Application, First Publication No. 2004-342330 (Claim 1, Paragraphs [0066] to [0070] and [0080]) of the related art, an insulating layer is formed by the electrodeposition means, but the insulating layer contains part of a solvent in addition to the polymer. Here, since baking of thermally curing the polymer of the insulating layer is performed by using heating means at a time, a surface of an insulating coating film is dried and hardened in advance in the middle of the baking when the film becomes thick, and then, the solvent in the insulating coating film evaporates and foams. As a result, a void is generated in the insulating coating film or a hole from which the void comes off is formed on the surface of the insulating coating film, and there is a concern that a withstanding voltage of the insulating coating film deteriorates.

An object of the present invention is to provide a method for producing an insulated electric wire in which foaming by evaporation of a solvent is suppressed even when an insulating coating film becomes thick, a void and a hole are not formed on the insulating coating film, and it is possible to increase a withstanding voltage of the insulated electric wire.

### SUMMARY OF THE INVENTION

### Solution to Problem

According to a first aspect of the present invention, there is provided a method for producing an insulated electric wire in which an insulating coating film is formed on a surface of an electric wire by performing baking treatment after forming an insulating layer on the surface of the electric wire by an electrodeposition method using an insulating electrodeposition coating material containing a polymer, the method including: performing pretreatment of evaporating a solvent in the insulating layer before the baking treatment; and performing the pretreatment by a near infrared ray heating furnace, in which a temperature of the pretreatment is lower than a temperature of the baking treatment.

According to a second aspect of the present invention based on the first aspect, further, a peak wavelength of the near infrared ray heating furnace is set to be within a range of 0.7 to 2.5 μm.

According to a third aspect of the present invention based on the first and second aspects, the temperature of the pretreatment is within a range of 50° C. to 200° C., and the temperature of the baking treatment is within a range of 200° C. to 500° C.

### Advantageous Effects of Invention

In the method for producing an insulated electric wire according to the first aspect of the present invention, since the pretreatment of evaporating the solvent in the insulating layer is performed before the baking treatment, the pretreatment is performed by the near infrared ray heating furnace, and the temperature of the pretreatment is lower than the temperature of the baking treatment, it is possible to reliably heat the electric wire before the insulating layer electrodeposited on the surface of the electric wire, the solvent in the insulating layer or the like is heated. Therefore, since the heating is gradually performed from a part at which the insulating layer electrodeposited on the surface of the electric wire is in contact with the electric wire to the surface, the evaporation of the solvent is performed in order from the part at which the solvent in the insulating layer is in contact with the electric wire to the surface. As a result, since the surface of the insulating layer is not dried and hardened first, it is possible to suppress foaming by evaporation of the solvent. Therefore, it is possible to make the insulating coating film thick, and to increase a withstanding voltage of the insulated electric wire.

### BRIEF DESCRIPTION OF THE DRAWINGS

FIG. 1 is a schematic view illustrating a process of forming an insulating coating film of an embodiment and examples of the present invention on a surface of an electric wire.

FIG. 2 is a view schematically illustrating an electrodeposition coating apparatus of the embodiment of the present invention.

FIG. 3 is a schematic view illustrating a process of forming an insulating coating film of an aspect of the related art and comparative examples on a surface of an electric wire.

### DETAILED DESCRIPTION OF THE INVENTION

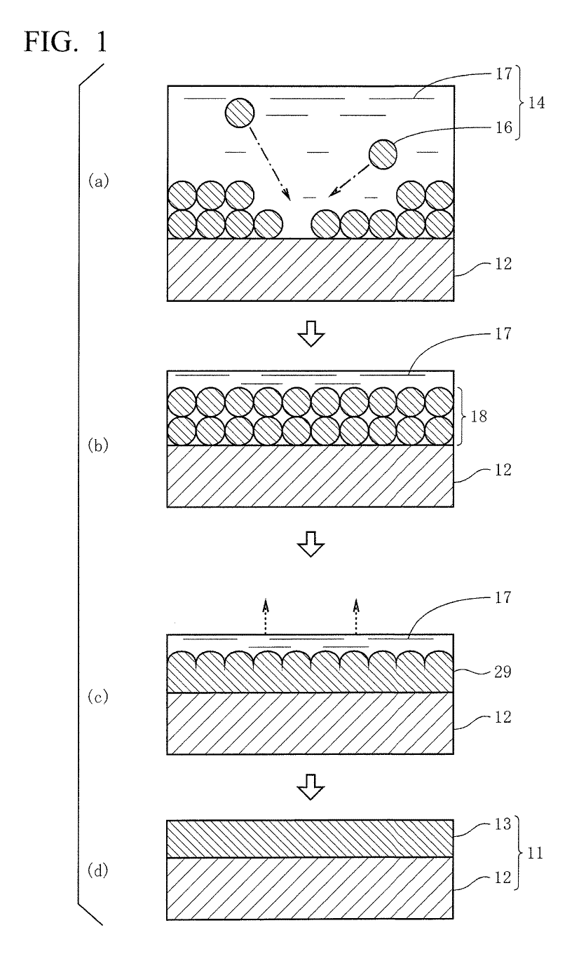

Next, an aspect for realizing the present invention will be described based on the drawings. As illustrated in FIG. 1(d), an insulated electric wire 11 includes an electric wire 12 and an insulating coating film 13 formed on a surface of the electric wire 12. In the electric wire 12, a cross section is formed in a flat square shape. In addition, as illustrated in FIGS. 1(a) to 1(d), the insulating coating film 13 is an insulating coating film containing a polymer in which an insulating electrodeposition coating material 14 containing a polymer (polymer particles 16) and a solvent 17 forms an insulating layer 18 on the surface of the electric wire 12 by an electrodeposition method, and the formed insulating layer 18 is heated and cured. The polymer (polymer particles 16) of the insulating electrodeposition coating material 14 may be any of an aqueous dispersion system and a water-soluble system. Furthermore, examples of the electric wire 12 include a copper wire, an aluminum wire, a steel wire, a copper alloy wire, an aluminum alloy wire or the like.

The method for producing an insulated electric wire configured in this manner will be described. First, the insulating electrodeposition coating material is prepared. In the insulating electrodeposition coating material of the present invention, a polymer, and an organic solvent and water which function as a solvent, are included. As the polymer, at least any one type of an acrylic resin, an epoxy resin, an epoxy-acrylic resin, a polyurethane resin, a polyester resin, a polyimide resin, a polyamideimide resin, and a polyesteramide resin is preferably included. In addition, examples of the organic solvent include one or more types selected from N,N-dimethylformamide (DMF), N,N-dimethylacetamide (DMAc), dimethyl sulfoxide (DMSO), N-methylpyrrolidone (NMP), γ-butyrolactone (γBL), anisole, tetramethylurea, and sulfolane. As the organic solvent, NMP is particularly preferable.

In the embodiment, a water dispersion type polyimide insulating electrodeposition coating material is prepared by using the polyimide resin as the polymer, and by using NMP as the organic solvent. Specifically, the water dispersion type polyimide insulating electrodeposition coating material is prepared, first, by adding a neutralizer into the polyimide solvent obtained by dissolving the polyimide resin into NMP and by stirring the polyimide solvent to neutralize polyimide, and then, by adding water which is a poor solvent of polyimide into the solvent in which polyimide is neutralizing, and by mixing and stirring the resultant to precipitate polyimide. A weight average molecular weight (Mw) of the polyimide is preferably 20,000 to 150,000, and is particularly preferably 45,000 to 90,000, by polystyrene conversion. Here, as the neutralizer, a basic compound of aminoethanol, triethylamine, triethanolamine, pyridine, or the like can be used. The water dispersion type polyimide insulating electrodeposition coating material prepared in this manner is a suspension in which the polymer particles made of the polyimide resin are dispersed. An average particle diameter of the polymer particles is preferably 0.01 to 10 μm, and is more preferably 0.05 to 1 μm. Here, the average particle diameter of the polymer particles is a particle diameter measured by using a particle diameter distribution measuring device (LA-950 manufactured by Horiba, Ltd.), and is a volume reference average particle diameter.

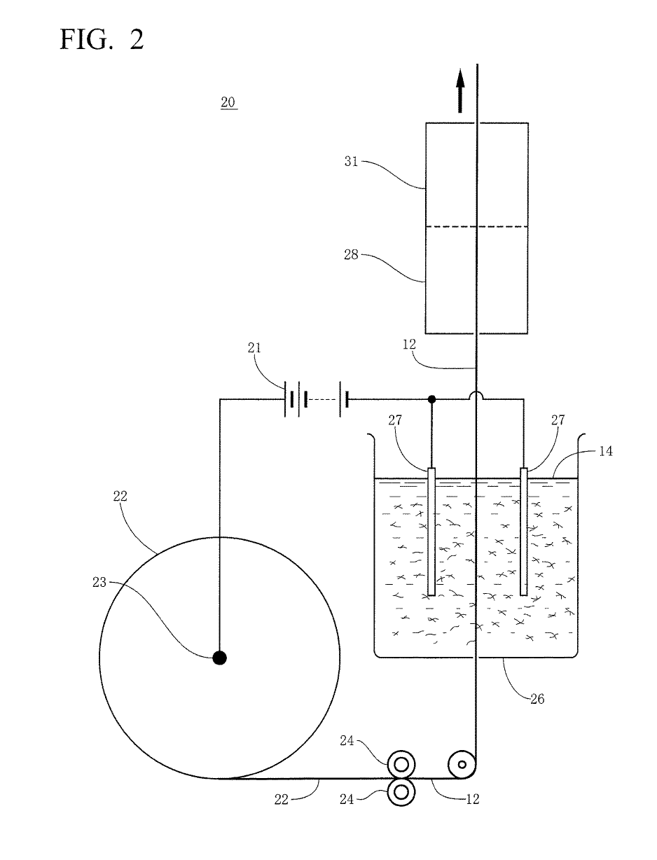

Next, as illustrated in FIG. 2, the insulating layer 18 (FIG. 1(b)) is formed by electrodepositing the insulating electrodeposition coating material 14 on the surface of the electric wire 12 by the electrodeposition method using an electrodeposition coating apparatus 20. Specifically, a columnar electric wire 22 (FIG. 2) having a circular cross section wound in a cylindrical shape is electrically connected to a positive electrode of a DC power source 21 via an anode 23. In addition, each process proceeds by pulling up the columnar electric wire 22 in the direction of an arrow illustrated by a solid line of FIG. 2. First, as a first process, the rectangular wire 12 having a rectangular cross section is obtained by extending the columnar electric wire 22 to be flat by one pair of rolling rollers 24. Next, as a second process, the insulating electrodeposition coating material 14 is stored in an electrodeposition tank 26 (FIGS. 1(a) and 2), and the rectangular wire 12 passes through the insulating electrodeposition coating material 14 in the electrodeposition tank 26. Here, in the insulating electrodeposition coating material 14 in the electrodeposition tank 26, a cathode 27, which is provided having an interval with the rectangular wire 12 that passes through and which is electrically connected to a negative electrode of the DC power source 21, is inserted. When the rectangular wire 12 passes through the insulating electrodeposition coating material 14 in the electrodeposition tank 26, a DC voltage is applied between the rectangular wire 12 and the insulating electrodeposition coating material 14 by the DC power source 21 (FIG. 2). Accordingly, the polymer particles 16 dispersed in the solvent 17 of the insulating electrodeposition coating material 14 is electrodeposited on the surface of the rectangular wire 12 and the insulating layer 18 is formed (FIGS. 1(a) and 1(b)).

Here, the temperature of the insulating electrodeposition coating material 14 in the electrodeposition tank 26 is preferably 5° C. to 60° C. Concentration of polymers in the insulating electrodeposition coating material 14 is preferably 1 to 40% by mass. In addition, the DC voltage of the DC power source 21 is preferably 1 to 300 V, and the energization time of a DC current is preferably 0.01 to 30 seconds.

Next, drying is performed as pretreatment of baking treatment with respect to the rectangular wire 12 in which the insulating layer 18 is electrodeposited on the surface, the solvent in the insulating layer 18 is evaporated, and an insulating layer 29 is obtained by the evaporation of the solvent in the insulating layer 18. The drying as the pretreatment is performed by a near infrared ray heating furnace. In the embodiment, by allowing the rectangular wire 12 pulled up from the electrodeposition tank 26 to pass through the inside of a near infrared ray heating furnace 28 (FIG. 2), the drying which is the pretreatment is performed. A peak wavelength of the near infrared ray heating furnace is preferably set to be within a range of 0.7 to 2.5 μm. Examples of a heating source in the near infrared ray heating furnace 28 include a halogen lamp heater, a tungsten heater or the like. In addition, the temperature of the pretreatment is set to be lower than the temperature of the baking treatment which will be described later. Furthermore, the temperature of the pretreatment is preferably within a range of 50° C. to 200° C., and the time of the pretreatment is preferably within a range of 1 to 10 minutes. In addition, the temperature of the pretreatment is a temperature of a center portion in the near infrared ray heating furnace measured by a thermocouple. The peak wavelength of the near infrared ray heating furnace is more preferably set to be within a range of 1 to 2 μm, and the temperature of the pretreatment is more preferably within a range of 100° C. to 190° C., but the peak wavelength and the temperature are not limited thereto.

The peak wavelength of the near infrared ray heating furnace is limited to be within the range of 0.7 to 2.5 μm. Because when the peak wavelength is less than 0.7 μm, it is not possible to sufficiently heat the electric wire and the insulating layer. When the peak wavelength exceeds 2.5 μm, the surface of the insulating layer is heated before the electric wire, and dry and hard is performed from the surface of the insulating layer, and after this, the solvent in the insulating layer is evaporated and foams, and a void or a hole is formed on the cured insulating coating film by the foaming. In addition, the temperature of the pretreatment is set to be lower than the temperature of the baking treatment because of a reason that the foaming is likely to occur when the temperature of the pretreatment is high. In addition, the temperature of the pretreatment is limited to be within the range of 50° C. to 200° C. because it is not possible to sufficiently dry the insulating layer when the temperature is less than 50° C., and the foaming is likely to occur when the temperature exceeds 200° C. Furthermore, the time of the pretreatment is limited to be within a range of 1 to 10 minutes because it is not possible to sufficiently dry the insulating layer when the time is less than 1 minute, and productivity deteriorates when the time exceeds 10 minutes.

Accordingly, as illustrated in FIGS. 1(a) to 1(c), it is possible to heat the electric wire 12 before heating the insulating layer 18 formed by electrodepositing the polymer (polymer particles 16) in the insulating electrodeposition coating material 14 on the surface of the electric wire 12, the solvent 17 in the insulating layer 18, or the solvent 17 on the surface of the insulating layer 18. Therefore, since the heating is gradually performed from the part at which the insulating layer 18 is in contact with the electric wire 12 to the surface, the evaporation of the solvent 17 is performed in order from the part at which the solvent 17 in the insulating layer 18 is in contact with the electric wire 12 to the surface. FIG. 1(c) illustrates a process in which the solvent evaporates by the pretreatment. As a result, since the surface of the insulating layer 18 is not dried and hardened in advance, even when the solvent 17 in the insulating layer 18 evaporates, the solvent passes through the liquid solvent 17, and does not remain as a void or a hole in the insulating layer 29 after the drying.

Furthermore, by performing the baking treatment with respect to the insulating layer 29 dried in the pretreatment, the insulating coating film 13 is formed on the surface of the electric wire 12 (FIG. 1(d)). In the embodiment, as illustrated in FIG. 2, the electric wire 12 on which the insulating layer 29 is formed on the surface thereof passes through the inside of a baking furnace 31. The baking treatment is preferably performed by a near infrared ray heating furnace, a hot air heating furnace, an induction heating furnace, a far infrared ray heating furnace or the like. In addition, the temperature of the baking treatment is preferably within a range of 200° C. to 500° C., and the time of the baking treatment is preferably within a range of 1 to 10 minutes. Here, the temperature of the baking treatment is limited to be within a range of 200° C. to 500° C. because it is not possible to sufficiently cure the insulating layer when the temperature is less than 200° C., and the polymer is thermally decomposed when the temperature exceeds 500° C. In addition, the time of the baking treatment is limited to be within the range of 1 to 10 minutes because it is not possible to sufficiently cure the insulating layer when the time is less than 1 minutes, and the resin is thermally decomposed when the time exceeds 10 minutes. In addition, the temperature of the baking treatment is the temperature of the center portion in the baking furnace. The temperature of the baking treatment is more preferably within a range of 220° C. to 400° C., but the temperature is not limited thereto.

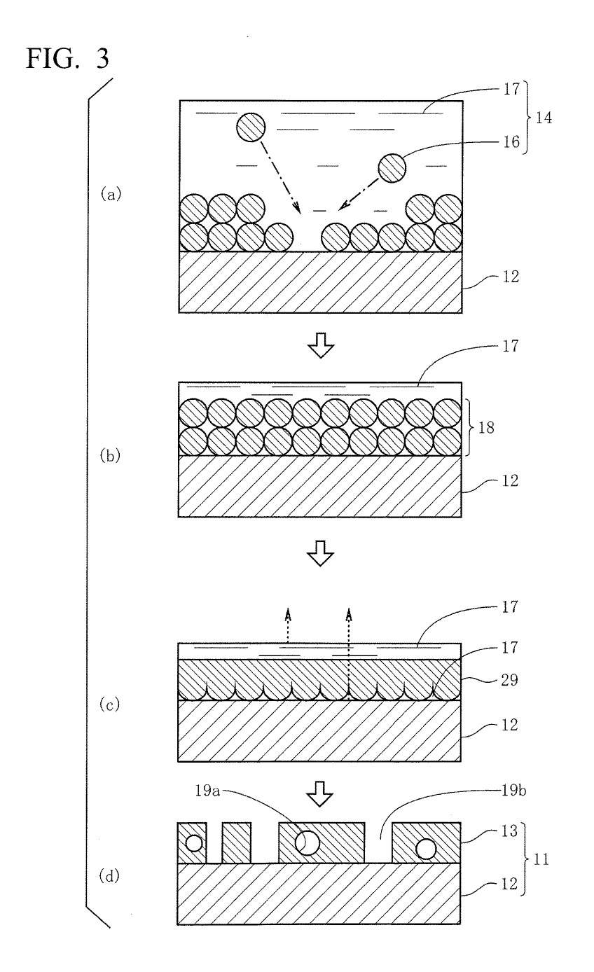

Accordingly, as illustrated in FIG. 1(d), without forming the void and the hole on the insulating coating film 13 cured after the baking treatment, and without occurrence of the foaming due to the evaporation of the solvent even when the insulating coating film 13 is made thick, it is possible to increase a withstanding voltage of the insulated electric wire 11. The film thickness of the insulating coating film 13 can be thick to be approximately 5 to 100 μm. In addition, in a case where the pretreatment of evaporating the solvent is not performed before the baking treatment, that is, as illustrated in FIGS. 3(b) and 3(c), in a case where the pretreatment (drying treatment) and the baking treatment are performed at the same time, the insulating layer 18 is gradually heated from the surface thereof to the part at which the insulating layer 18 is in contact with the electric wire 12, and thus, the surface of the insulating layer 18 is dried and hardened before the part at which the surface of the insulating layer 18 is in contact with the electric wire 12. FIG. 3(c) illustrates an evaporation process of the solvent when the baking treatment and the drying treatment are performed at the same time. As a result, when the solvent 17 in the insulating layer 18 evaporates, as illustrated in FIG. 3(d), a void 19a is formed on an inner side of the insulating layer 29 in which the surface is dried and hardened, or a hole 19b is formed in the cured insulating coating film 13 when the void comes off to the surface. Therefore, the foaming occurs when the insulating coating film 13 is made thick, and it is not possible to increase the withstanding voltage of the insulated electric wire 11.

### EXAMPLES

Next, examples and comparative examples of the present invention will be described in detail.

### Example 1

First, the water dispersion type polyimide insulating electrodeposition coating material containing 5% by weight of polyimide was stored in the electrodeposition tank. The average particle diameter of the polymer particles in the insulating electrodeposition coating material was 0.4 μm. The temperature of the insulating electrodeposition coating material in the electrodeposition tank was 25° C. Then, a rectangular copper wire (electric wire) having a width of 2 mm and a thickness of 0.1 mm was an anode, and a stainless steel sheet inserted into the insulating electrodeposition coating material in the electrodeposition tank was a cathode. In a state where 50V of DC voltage was applied between the rectangular copper wire and the stainless steel sheet, the rectangular copper wire passed through the insulating electrodeposition coating material in the electrodeposition tank at a wire speed of 5 m/minute. Accordingly, polymer (polyimide) was electrodeposited on the surface of the rectangular copper wire and the insulating layer was formed. The time during which the rectangular copper wire was in contact with the insulating electrodeposition coating material in the electrodeposition tank was 5 seconds. Next, the pretreatment was performed with respect to the rectangular copper wire in which the insulating layer was formed on the surface. Specifically, the pretreatment was performed by allowing the rectangular copper wire in which the insulating layer was formed on the surface to pass through the near infrared ray heating furnace that was held at a temperature of 180° C. at a wire speed of 5 m/minute. Accordingly, the solvent in the insulating layer formed on the surface of the rectangular copper wire evaporated. Here, the halogen lamp heater was used as a heating source in the near infrared ray heating furnace. The peak wavelength of the halogen lamp heater was 1 μm. In addition, the temperature in the near infrared ray heating furnace was the temperature in the center portion in the furnace measured by the thermocouple. Furthermore, the baking treatment was performed with respect to the rectangular copper wire in which the insulating layer obtained as the solvent evaporates was formed on the surface. Specifically, the insulated electric wire in which a thickness of the insulating coating film was 20 μm was produced by performing the baking treatment by allowing the rectangular copper wire in which the insulating layer obtained as the solvent evaporates was formed on the surface to pass through the baking furnace held at the temperature of 250° C. Here, the halogen lamp heater was used as the heating source in the baking furnace. The peak wavelength of the halogen lamp heater was 1 μm. In addition, the temperature in the baking furnace was the temperature in the center portion in the furnace measured by the thermocouple. Furthermore, the insulated electric wire in which the thickness of the insulating coating film was 30 μm was produced by changing a voltage value when allowing the copper wire to pass through the insulating electrodeposition coating material in the electrodeposition tank to 75 V. In addition, the insulated electric wire in which the thickness of the insulating coating film was 40 μm was produced by changing the voltage value when allowing the copper wire to pass through the insulating electrodeposition coating material in the electrodeposition tank to 100 V. The insulated electric wires were considered as Example 1.

### Example 2 and Comparative Examples 1 to 5

Regarding the insulated electric wires of Example 2 and Comparative Examples 1 to 5, the insulated electric wires in which the thicknesses of the insulating coating film were 20 μm, 30 μm, and 40 μm, were produced by changing the heating source of the pretreatment, the temperature of the pretreatment, the heating source of the baking treatment, the temperature of the baking treatment, and the order of the pretreatment and the baking treatment, as illustrated in Table 1. In addition, the insulated electric wire was manufactured similar to Example 1 other than the fact that the heating source of the pretreatment, the temperature of the pretreatment, the heating source of the baking treatment, the temperature of the baking treatment, the thickness of the insulating coating film, and the order of the pretreatment and the baking treatment were changed as illustrated in Table 1.

<Comparative Test 1 and Evaluation>

With respect to the insulated electric wires in Examples 1 and 2 and Comparative Examples 1 to 5, the withstanding voltages were measured by an AC withstanding tester (TOS5000 manufactured by Kikusui Electronics Corp.). The result thereof is illustrated in Table 1. In addition, in Table 1, the film thickness was the thickness of the insulating coating film. In addition, in Table 1, the void and the hole indicate a state where the foaming occurs by the evaporation of the solvent and the void was formed in the insulating coating film or the hole was formed on the surface of the insulating coating film, and indicates that the withstanding voltage cannot be measured. Furthermore, in Table 1, insufficient baking indicates a state where the polymer is not sufficiently thermally cured.

TABLE 1

| | | | | | Order of | Withstanding voltage (kV) | | |
|---|---|---|---|---|---|---|---|---|
| | Pretreatment | | Baking treatment | | pretreatment | Film | Film | Film |
| | Heating | Temperature | Heating | Temperature | and baking | thickness | thickness | thickness |
| | source | (° C.) | source | (° C.) | treatment | 20 μm | 30 μm | 40 μm |
| Example 1 | Halogen | 180 | Halogen | 250 | Baking | 5 | 7 | 10 |
| | lamp | | lamp | | treatment after | | | |
| | heater | | heater | | pretreatment | | | |
| Example 2 | Halogen | 180 | Hot | 250 | Baking | 5 | 7 | 10 |
| | lamp | | wind | | treatment after | | | |
| | heater | | | | pretreatment | | | |
| Comparative | Hot | 180 | Hot | 250 | Baking | 5 | 7 | Void and |
| example 1 | wind | | wind | | treatment after | | | hole |
| | | | | | pretreatment | | | |
| Comparative | Halogen | 250 | Halogen | 250 | Both are | 5 | Void and | Void and |
| example 2 | lamp | | lamp | | performed at | | hole | hole |
| | heater | | heater | | the same time | | | |
| Comparative | Hot | 250 | Hot | 250 | Both are | 5 | Void and | Void and |
| example 3 | wind | | wind | | performed at | | hole | hole |
| | | | | | the same time | | | |
| Comparative | Halogen | 180 | Halogen | 180 | Both are | 2 | 3 | 4 |
| example 4 | lamp | | lamp | | performed at | Insufficient | Insufficient | Insufficient |
| | heater | | heater | | the same time | baking | baking | baking |
| Comparative | Hot | 180 | Hot | 180 | Both are | 2 | 3 | Void and |
| example 5 | wind | | wind | | performed at | Insufficient | Insufficient | hole |
| | | | | | the same time | baking | baking | |

As is apparent from Table 1, in the insulated electric wires of Comparative Examples 1, 3, and 5, since hot wind was used as the heating source of the pretreatment, when the thickness of an insulating film was 40 μm, the void or the hole was formed on the insulating coating film. In addition, in the insulated electric wire of Comparative Examples 2 and 4, since the temperature of the pretreatment and the temperature of the baking treatment were the same as each other, when the thickness of the insulating film was thick to be 40 μm, the void or the hole were formed on the insulating coating film, or insufficient baking of the insulating coating film occurs. In the insulated electric wires of Examples 1 and 2, by using the halogen lamp heater of the near infrared ray heating furnace as the heating source of the pretreatment, the temperature of the pretreatment was lower than the temperature of the baking treatment, and thus, even when the thickness of the insulating film was thick to be 40 μm, the void and the hole were not formed on the insulating coating film, and the insulated electric wire withstood 10 kV of AC voltage.

### Examples 3 to 6

Regarding the insulated electric wires of Examples 3 to 6, the insulated electric wires in which the thickness of the insulating coating film was 40 μm were produced by changing the temperature of the pretreatment and the temperature of the baking treatment as illustrated in Table 2. In addition, the insulated electric wire in which the thickness of the insulating coating film was 40 μm was produced similar to Example 1 other than the temperature of the pretreatment and the temperature of the baking treatment illustrated in Table 2.

<Comparative Test 2 and Evaluation>

With respect to the insulated electric wires of Examples 3 to 6, similar to Comparative Test 1, the withstanding voltages were measured by the AC withstanding tester (TOS5000 manufactured by Kikusui Electronics Corp.). Here, the halogen lamp heater was used as the heating source of the pretreatment, the hot wind furnace was used as the heating source of the baking treatment, and the thickness of the insulating film was 40 μm. The result thereof is illustrated in Table 2.

TABLE 2

| | Temperature of | Temperature of | Withstanding |
|---|---|---|---|
| | pretreatment | baking treatment | voltage |
| | (° C.) | (° C.) | (kV) |
| Example 3 | 200 | 250 | 10 |
| Example 4 | 50 | 250 | 10 |
| Example 5 | 150 | 500 | 10 |
| Example 6 | 150 | 200 | 10 |

As is apparent from Table 2, in the insulated electric wires of Examples 3 to 6, the void and the hole were not formed on the insulating coating film, and the insulated electric wire withstood 10 kV of AC voltage.

### INDUSTRIAL APPLICABILITY

A method for producing an insulated electric wire of the present invention can be used in a transistor of an on-vehicle inverter, a reactor, a motor or the like.

### REFERENCE SIGNS LIST

11 INSULATED ELECTRIC WIRE
12 RECTANGULAR WIRE (ELECTRIC WIRE)
13 INSULATING COATING FILM
14 INSULATING ELECTRODEPOSITION COATING MATERIAL
17 SOLVENT
18, 29 INSULATING LAYER

1. A method for producing an insulated electric wire in which an insulating coating film is formed on a surface of an electric wire by performing baking treatment after forming an insulating layer on the surface of the electric wire by an electrodeposition method using an insulating electrodeposition coating material containing a polymer, the method comprising:
performing pretreatment of evaporating a solvent in the insulating layer before the baking treatment; and
performing the pretreatment by a near infrared ray heating furnace,
wherein a temperature of the pretreatment is lower than a temperature of the baking treatment.

2. The method for producing an insulated electric wire according to claim 1,
wherein a peak wavelength of the near infrared ray heating furnace is set to be within a range of 0.7 to 2.5 μm.

3. The method for producing an insulated electric wire according to claim 1,
wherein the temperature of the pretreatment is within a range of 50° C. to 200° C., and the temperature of the baking treatment is within a range of 200° C. to 500° C.
